(19) United States
(12) Patent Application Publication
(10) Pub. No.: US 2011/0262666 A1
(43) Pub. Date: Oct. 27, 2011

(54) THERMAL TRANSFER RIBBON CONTAINING EXFOLIATED LAYERED INORGANIC NANOPARTICLES OR EXFOLIATED LAYERED DOUBLE HYDROXIDE NANOPARTICLES AND MANUFACTURING METHOD THEREOF

(76) Inventors: Jin Ho Choy, Seoul (KR); Dae Hwan Park, Daejeon (KR); Won Woo Park, Seoul (KR); Jae Sang Ryu, Jeollabuk-do (KR)

(21) Appl. No.: 12/936,205

(22) PCT Filed: Apr. 23, 2010
(86) PCT No.: PCT/KR10/02574

§ 371 Date: Oct. 1, 2010

(51) Int. Cl. B41M 5/382; B05D 1/00; B82Y 99/00

(52) U.S. Cl. 428/32.67; 427/152; 977/755

(57) ABSTRACT

The present invention relates to a thermal transfer ribbon containing exfoliated layered inorganic nanoparticles or exfoliated layered double hydroxides and a manufacturing method thereof, and more particularly to a sublimation thermal transfer ribbon wherein a second adhesive layer, a transfer ink layer and a transfer protective layer are formed on one surface of a base film having a lubricating heat-resistant layer and a first adhesive layer formed on the other surface thereof, in which the lubricating heat-resistant layer, the transfer ink layer and the transfer protective layer contain exfoliated layered inorganic nanoparticles or exfoliated layered double hydroxide nanoparticles to improve the heat resistance, image uniformity and abrasion resistance of the thermal transfer ribbon.

### TECHNICAL FIELD

The present invention relates to a thermal transfer ribbon containing exfoliated layered inorganic nanoparticles or exfoliated layered double hydroxides and a manufacturing method thereof, and more particularly to a sublimation thermal (printing) transfer ribbon wherein a second adhesive layer, a transfer ink layer and a transfer protective layer are formed on one surface of a base film having a lubricating heat-resistant layer and a first adhesive layer formed on the other surface thereof, in which the lubricating heat-resistant layer, the transfer ink layer and the transfer protective layer contain exfoliated layered inorganic nanoparticles or exfoliated layered double hydroxide nanoparticles to improve the heat resistance, image uniformity and abrasion resistance of the thermal transfer ribbon.

### BACKGROUND ART

Methods for recording color images include electrophotographic methods, inkjet methods, thermal transfer methods and the like. Among them, the thermal transfer recording methods are being used in a wide range of applications, because there is no noise during printing and it is easy to maintain and repair the device. In these thermal transfer methods, a color image produced by an electrical signal is separated by color filters into three-color images, red (R), green (G) and blue (B), and the separated three-color images are transmitted in the form of electrical signals to the thermal transfer head of a printer. According to the transmitted signals, thermal energy is applied by the thermal transfer head to one surface of a thermal transfer ribbon, which is opposite the surface having a transfer ink layer applied thereto, and thus either three color materials of yellow, magenta and cyan or four color materials of yellow, magenta, cyan and black are transferred to an ink receiving material to obtain an image.

These thermal transfer methods are roughly classified into a melt thermal transfer method and a sublimation thermal transfer method. The melt thermal transfer method is a method in which the transfer ink layer is heated and melted by a thermal element and the melted ink is transferred to a receiving layer and then solidified. However, in the melt thermal transfer method, not only the color material, but also the binder component, is transferred to the receiving layer in the thermal transfer process, and for this reason, this method has a limitation in displaying a continuous gradation. Contrary to this method, the sublimation thermal transfer method is a method in which the thermal transfer layer is composed of a thermal sublimation dye and a binder resin and also in which only the dye is transferred to a card in proportion to thermal energy applied by a thermal element so as to form an image. This sublimation thermal transfer method is also called the “dye-diffusion thermal transfer method”. The sublimation thermal transfer method has an advantage in that it is easy to display a continuous gradation in the transferred image, because the amount of dye transferred is controlled in proportion to thermal energy applied.

Accordingly, the sublimation thermal transfer method can produce a very high quality image, and thus it is used in the graphic design field or to print images, which have been generated electronically from a color video camera, through a color printer.

In the general structure of the sublimation thermal transfer ribbon, a transfer ink layer for transferring ink to an ink-receiving material (card, receiving paper, etc.) is applied to one surface of a base film, and an adhesive layer for improving the adhesion between the transfer ink layer and the base film is formed between the transfer ink layer and the base film. On the surface opposite the surface having the transfer ink layer applied thereto is formed a lubricating heat-resistant layer for preventing damages to the substrate (for example, preventing the base film from sticking or tearing due to heat generated in the thermal transfer head during printing).

When this thermal transfer ribbon is used to transfer an image, instantaneous heat transferred to the ribbon during the movement of the thermal transfer head reaches the maximum of 400° C. If the heat resistance of the lubricating heat-resistant layer is insufficient, the heated portion of the ribbon will be reduced in strength due to thermal deformation during image transfer to cause tearing of the ribbon in severe cases. If the surface of the lubricating heat-resistance layer is not uniform, the thermal transfer head will be damaged during the running thereof. Japanese Patent Registration Nos. 58-192959 and 59-82251 disclose a thermal transfer film comprising: a substrate made of PEC; a transfer ink layer formed on one surface of the substrate; and a heat-resistant layer and a lubricating heat-resistant layer sequentially formed on the other surface of the substrate in order to prevent the film from being thermally deformed by high temperature. However, these prior patents have shortcomings in that, because the heat-resistant layer is further included to make the thermal transfer film excessively thick, the sensitivity at which the thermal transfer head presses the ribbon at a predetermined pressure is reduced to make it difficult to control the amount of dye transferred, and also in that it is difficult to manufacture a uniform film for the ribbon.

Because a printing ribbon is generally wound on a reel, the transfer ink layer of the ribbon comes in contact with the lubricating heat-resistant layer, and thus the dye in the transfer ink layer is slowly transferred to the lubricating heat-resistant layer over a long period of time. The dye stuck to the lubricating heat-resistant layer contaminates the thermal transfer head during the running of the head to cause damage to the thermal transfer head. Accordingly, in order to reduce the transfer of dye from the transfer ink layer and increase printability, the ink in the transfer ink layer should be firmly bound to the binder, and the surface of the transfer ink layer must be uniform.

Also, the chemical properties such as water resistance or chemical resistance of the prior image protective film manufactured as described above depend mainly on the properties of an acrylic resin constituting the transfer protective layer, and the physical properties such as abrasion resistance or rub resistance of the film are improved by a method of adding wax to the protective layer (U.S. Pat. No. 5,387,013). However, the method of said U.S. patent has a shortcoming in that, because the wax added to improve the physical properties of the film is not compatible with the acrylic resin that is the main component of the transfer protective layer, the interface therebetween is very weak. This weak interface acts as a penetration pathway upon contact with chemicals to reduce the chemical resistance of the film. Because recording media such as cards are mainly kept in purses or the like during the daily life of users, they come in contact with chemicals such as plasticizers over a long period of time. Substances such as plasticizers or acetones, which penetrated through this channel, cause damage to information. In order to prevent this damage, it is important to use a polymer material having excellent chemical resistance alone or in combination with acrylic resin to increase the chemical resistance of the film.

Accordingly, in order to hold the technology of photographic materials having worldwide quality, a thermal transfer ribbon should have good resistance to high-temperature heat generated in the thermal transfer head, should consist of layers having a uniform surface and should have excellent durability. Therefore, it is urgent to develop a sublimation thermal transfer ribbon having excellent heat resistance, durability, uniformity and coating uniformity.

Accordingly, the present inventors have made many efforts to solve the problems occurring in the prior art and, as a result, have found that, if either layered inorganic nanoparticles of various sizes modified with hydrophobic organic cations or layered metal double hydroxide nanoparticles of various sizes modified with hydrophobic organic anions are exfoliated by mixing them with a binder resin and then contained in the lubricating heat-resistant layer, transfer ink layer and transfer protective layer of a thermal transfer ribbon, the heat resistance, image uniformity and abrasion resistance of the thermal transfer ribbon are improved, thereby completing the present invention.

### SUMMARY of INVENTION

It is an object of the present invention to provide a sublimation thermal transfer ribbon wherein exfoliated layered inorganic nanoparticles or exfoliated layered double hydroxide nanoparticles are contained in the lubricating heat-resistant layer, transfer ink layer and transfer protective layer of the ribbon in order to improve the heat resistance, image uniformity and abrasion resistance of the ribbon.

To achieve the above object, the present invention provides a thermal transfer ribbon wherein a second adhesive layer, a transfer ink layer and a transfer protective layer are formed on one surface of a base film having a lubricating heat-resistant layer and a first adhesive layer formed on the other surface thereof, in which the lubricating heat-resistant layer, the transfer ink layer and the transfer protective layer contain exfoliated layered inorganic nanoparticles or exfoliated layered double hydroxide nanoparticles.

The present invention also provides a method for manufacturing a thermal transfer ribbon, the method comprising the steps of: (a) forming a first adhesive layer on one surface of a base film; (b) forming on the first adhesive layer a lubricating heat-resistant layer containing exfoliated layered inorganic nanoparticles or exfoliated layered double hydroxide nanoparticles; (c) forming a second adhesive layer on the surface opposite the surface of the base film on which the lubricating heat-resistant layer is formed; and (d) forming on the second adhesive layer a transfer ink layer and a transfer protective layer, which contain exfoliated layered inorganic nanoparticles or exfoliated layered double hydroxide nanoparticles.

Other features and embodiments of the present invention will be more apparent from the following detailed descriptions and the appended claims.

### BRIEF DESCRIPTION OF DRAWINGS

FIG. 1 schematically shows a thermal transfer ribbon according to the present invention.

FIG. 2 schematically shows a method of preparing an exfoliated layered inorganic nanoparticle resin according to the present invention.

FIG. 3 schematically shows an exfoliated layered double hydroxide nanoparticle resin according to the present invention.

### REFERENCE SIGNS LIST

10: lubricating heat-resistant layer
15: first adhesive layer
20: base film
25: second adhesive layer
30: transfer ink layer
35: transfer protective layer

### DETAILED DESCRIPTION OF THE INVENTION AND PREFERRED EMBODIMENTS

In one aspect, the present invention is directed to a thermal transfer (printing) ribbon wherein a second adhesive layer, a transfer ink layer and a transfer protective layer are formed on one surface of a base film having a lubricating heat-resistant layer and a first adhesive layer formed on the other surface thereof, in which the lubricating heat-resistant layer, the transfer ink layer and the transfer protective layer contain exfoliated layered inorganic nanoparticles or exfoliated layered double hydroxide nanoparticles.

Existing thermal transfer ribbons have poor print quality due to their non-uniform surface, whereas a thermal transfer ribbon according to the present invention comprises exfoliated layered inorganic nanoparticles or exfoliated layered double hydroxide nanoparticles contained in the lubricating heat-resistant layer, transfer ink layer and transfer protective layer thereof. Thus, in the case of the thermal transfer ribbon of the present invention, the heat transfer through the thermal transfer ribbon is uniform and controllable, the light resistance is excellent such that no spread of transfer dye occurs, and the heat resistance and durability can be improved.

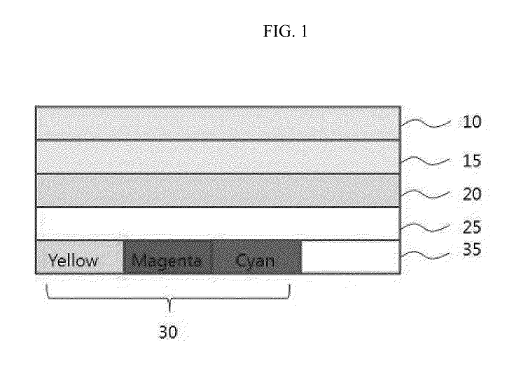

As shown in FIG. 1, the present invention provides a sublimation thermal transfer ribbon wherein a second adhesive layer 25, a transfer ink layer 30 and a transfer protective layer are formed on one surface of a base film 20 having a lubricating heat-resistant layer 10 and a first adhesive layer 15 formed on the other surface thereof, in which the lubricating heat-resistant layer 10, transfer ink layer 30 and transfer protective layer 35 of the sublimation thermal transfer ribbon contain exfoliated layered inorganic nanoparticles or exfoliated layered double hydroxide nanoparticles so as to be able to improve the heat resistance, image uniformity and abrasion resistance of the ribbon.

Recently, the development of materials using nanotechnology has been conducted in a wide range of industrial fields, because the heat resistance, uniformity, light resistance and chemical resistance of nanoparticle arrays are excellent. Accordingly, in the present invention, in order to provide a sublimation thermal transfer ribbon having excellent heat resistance, uniformity, light resistance and durability, exfoliated layered inorganic nanoparticles or exfoliated layered double hydroxide nanoparticles were used in a thermal transfer ribbon composition.

Generally, layered inorganic compounds are characterized in that they may mostly include various substances between the layers. In this regard, a variety of functional guest chemical species can be introduced by subjecting the metal ions constituting lattice layers to isomorphous substitution to generate layer ions or modifying the layers so as to impart physical and chemical adsorption properties. Also, it is well known that the pore sizes of porous inorganic compounds are controlled so as to physically adsorb molecules of selected size.

In the present invention, the layered inorganic nanoparticles may be layered silicates having a mean particle size ranging from 10 nm to 2 μm.

In the present invention, silicates in the layered silicates have a pyramidal SiO₄ tetrahedron as a building block. For example, in the case of layered aluminosilicates, two sheets of SiO₄ tetrahedrons are arranged so that the apexes of the tetrahedrons face each other, and the apexes are connected to each other by metal ions (i.e., aluminum) to form sandwich layers (i.e., layers of Si—Al—Si), which are vertically arranged to have a layered structure.

In such layered silicates, Si⁴⁺ of the SiO₄ tetrahedron, which is the fundamental building block of each layer, can be substituted with Al³⁺ and thus the layered structure has a negative charge and, thereby has an ion exchange capacity.

In some cases, Al³⁺ linking SiO₄ tetrahedrons together may be substituted with Me, so that the layered structure may have negative charges. In order to compensate for such negative charges, alkaline metal cations or alkaline earth metal cations (Na⁺, Ca²⁺, etc.) exist between the layers of the layered structure, and these interlayer metal ions such as Si, Al or Mg can be readily substituted with other cations or cationic organic compounds compared to the metal ions existing in the layers.

Layered silicates which can be used in the present invention may be layered inorganic nanoparticles of various particle sizes, such as smectite clay minerals, including such as montmorillonite, hectorite, saponite, bentonite, fluorohectorite, beidelite, nontronite, stevensite, vermiclite, volkonskoite, sauconite, magadite, kenyalite, and their derivatives. Such layered silicates may be modified with hydrophobic organic cations to obtain layered inorganic nanoparticles compatible with hydrophobic compounds.

The layered silicates according to the present invention are modified with hydrophobic organic cations at the interlayer thereof, wherein the hydrophobic organic cations enlarges the interlayer distance of the interlayer compound, and at the same time, changes the hydrophilic interlayer portion of the interlayer compound to be hydrophobic, thus making the interlayer compound compatible (mixable) with a variety of organic compounds, particularly with binder polymers.

In the present invention, the hydrophobic organic cations are preferably selected from the group consisting of, but not limited to, primary to quaternary ammonium ions, such as benzyl trimethyl ammonium chloride ions or dimethyl dioctadecyl ammonium chloride ions, primary to quaternary phosphonium ions such as alkyl phosphonium ions or aryl phosphonium ions, and mixtures thereof.

In the present invention, the layered double hydroxide (LDH) nanoparticles may have a mean particle size ranging from 10 nm to 2 μm.

Also, in the present invention, the layered double hydroxides (LDHs) consist of water and anions offsetting the positive charges in the positively charged metal oxide layers and between the layers and may be a generic term for a variety of trivalent and divalent cationic hydroxides. Such layered double hydroxides can generally be represented by the following formula 1:

[M²⁺₁₋ₓN³⁺ₓ(OH)₂][Aⁿ⁻]_{x/n}.yH₂O [Formula 1]

where M represents a divalent metal cation such as Mg²⁺, Ni²⁺, Cu²⁺ or Zn²⁺, N represents a trivalent metal cation such as Al³⁺, Cr³⁺, Fe³⁺, V³⁺ or Ga³⁺, A represents n charged anionic chemical species such as NO₃⁻, CO₃²⁻, Cl, SO₄²⁻, metalate or organic acid anions, x is an integer of more than (greater than) 0 but smaller than 1, y is a positive number, and n is an integer. The layer charge density can be controlled by changing the metal ratio according to “x”, and various negative ions indicated by “A” can be simply introduced between the hydroxide layers through an ion exchange reaction and a co-precipitation reaction.

Accordingly, in the present invention, among the above-described layered double hydroxides, stable magnesium- and aluminum-based layered double hydroxides can be used to synthesize layered double hydroxide nanoparticles modified with a hydrophobic organic compound, wherein the ratio of a divalent metal cation to a trivalent metal cation can be controlled to 2:1, 3:1 and 4:1 to form a composite whose layer charge is controlled.

In order to improve the dispersibility of layered double hydroxides in a binder as described below and improve the swellability of layered double hydroxides in a non-aqueous solvent such as alcohol, the layered double hydroxides which are used in the present invention are modified with hydrophobic organic anions. The hydrophobic organic anions are preferably selected from the group consisting of alkyl sulfate ions, alkyl alcoholate ions, alkyl carboxylate ions, and mixtures thereof.

In the present invention, the lubricating heat-resistant layer 10 contains, as main components, a binder resin containing exfoliated layered inorganic nanoparticles or layered double hydroxide nanoparticles, a hydroxyl group-containing compound as a lubricating agent, and an isocyanate-containing compound as a curing agent. However, hydrophobically modified layered inorganic nanoparticles or hydrophobically modified layered double hydroxide nanoparticles may also be contained in a conventional lubricating heat-resistant layer composition.

In the present invention, a binder which is used in the lubricating heat-resistant layer 10, the transfer ink layer 30 and the transfer protective layer 35 must be readily dissolved in a solvent, must not be separated into phases when mixed with a lubricating agent, and must be a highly heat-resistant polymer having a glass transition temperature (Tg) higher than 80° C. Examples of binders having such physical properties, which can be used in the present invention, include polyvinyl butyral, nitrocellulose, polyvinyl acetate resins (including polyvinyl acetacetal resin), acrylate resins (including polymethylmethacrylate), polyester resin, styrene-butadiene copolymers, polyurethane acrylate, polyester acrylate, and mixtures thereof. Preferably, polyvinyl butyral is used.

As the curing agent in the present invention, polyisocyanate, diphenylmethane diisocyanate, tetramethylxylene diisocyanate, toluene diisocyanate or the like may be used.

In the present invention, an agent for providing activity (such as surfactant) serving as a lubricating agent may be contained in the lubricating heat-resistant layer. This surfactant can be selected from the group consisting of phosphoric acid ester, silicone oil, epoxy-modified silicone, acrylic modified silicone, urethane-modified silicones, polyether-modified silicone, a fluorine-based graft polymer, and mixtures thereof.

In the present invention, a coating solvent for the lubricating heat-resistant layer 10 may be selected from the group consisting of, but not limited to, alcohol, glycol ether, ketone, toluene, dimethyl formamide, ethyl acetate, methyl ethyl ketone, and mixtures thereof, in view of solubility and workability.

In the present invention, the lubricating heat-resistant layer 10 contains, based on 100 parts by weight of a binder, 5-60 parts by weight of exfoliated layered inorganic nanoparticles or exfoliated layered double hydroxide nanoparticles, 20-130 parts by weight of a curing agent and 10-50 parts of an agent for providing activity.

If the exfoliated layered inorganic nanoparticles or exfoliated layered double hydroxide nanoparticles are contained in an amount of less than 5 parts by weight based on 100 parts by weight of the binder, the effect thereof will be insignificant, and if the exfoliated layered inorganic nanoparticles or the exfoliated layered double hydroxide nanoparticles are contained in an amount of more than 60 parts by weight, the viscosity of the coating solution will be increased, thus making the coating operation difficult.

If the curing agent is contained in an amount of less than 20 parts by weight based on 100 parts by weight of the binder, the formation of a network structure in the coating film will be insufficient so that the strength of the coating film will be insufficient, thus making it impossible to obtain sufficient heat resistance, and if the curing agent is contained in an amount of more than 130 parts by weight, the adhesive strength of the lubricating heat-resistant layer to the base film will be reduced due to a rapid curing reaction during coating, and a uniform lubricating heat-resistant layer cannot be formed.

If the agent for providing activity is added to the lubricating heat-resistant layer 10 in an amount of less than 10 parts by weight based on 100 parts by weight of the binder, a sufficient lubricating property cannot be obtained, and if it is added in an amount of more than 50 parts by weight, it can reduce the coating strength of the lubricating heat-resistant layer.

In the present invention, the coating thickness of the lubricating heat-resistant layer 10 is preferably maintained at a thickness of 0.5-2.0 μm after drying. If the coating thickness of the lubricating heat-resistant layer 10 is less than 0.5 μm, the lubricating heat-resistant layer 10 will be ineffective so that the thermal transfer ribbon can tear, and if the coating thickness exceeds 2.0 μm, the color tone of the transferred image will become thin.

The lubricating heat-resistant layer 10 according to the present invention contains a binder resin containing exfoliated hydrophobic layered inorganic nanoparticles or exfoliated hydrophobic layered double hydroxide nanoparticles, and thus it is effective in improving the heat resistance of the thermal transfer ribbon due to the excellent heat resistance of nanoparticle arrays, even if it is not additionally provided with a heat-resistant layer.

In the present invention, the base film 20 may be made of a polyester film such as polyethylene terephthalate, or a polyamide, polyacrylate, a polycarbonate, cellulose ester, fluorine-based resin, polyacetal or polyimide film. Preferably, a polyethylene terephthalate film is used. Herein, the thickness of the base film 20 is 4-20 μm, and preferably 4-6 μm, such that it can be prevented from being bent due to the formation of coating layers thereon.

In the present invention, in order to impart adhesion to the base film 20, the first and second adhesive layers are formed on both surfaces of the base film, respectively, on which the lubricating heat-resistant layer 10 and the transfer ink layer 30 are formed, respectively. These first and second adhesive layers can be formed by corona treatment or by coating the base film with one or a mixture of two or more selected from among a p-chlorophenol solution, a vinyl chloride-vinyl acetate copolymer, polyester resin, polyurethane resin, acrylic resin, butyral resin, vinyl chloride resin, and epoxy resin.

In the present invention, the coating thickness of each of the first and second adhesive layer 15 and 25 after drying is preferably 0.02-1.0 μm in view of adhesion and transfer sensitivity. After the second adhesive layer 25 has been coated on the base film 20 as described above, the transfer ink layer 30 is coated thereon. The transfer ink layer 30 generally comprises a thermally sublimable dye and a binder as main components.

In the present invention, the transfer ink layer 30 contains, based on 100 parts by weight of a binder, 2-30 parts by weight of exfoliated layered inorganic nanoparticles or exfoliated layered double hydroxide nanoparticles, 1-10 parts by weight of a lubricating agent and 50-200 parts by weight of a dye. If the exfoliated layered inorganic nanoparticles or exfoliated layered double hydroxide nanoparticles are contained in an amount of less than 2 parts by weight based on 100 parts by weight of the binder, the effect thereof will be insignificant, and if the exfoliated layered inorganic nanoparticles or exfoliated layered double hydroxide nanoparticles are contained in an amount of more than 30 parts by weight, the transfer sensitivity of the dye can be reduced.

If the lubricating agent is contained in an amount of less than 1 part by weight based on 100 parts by weight of the binder, the transfer ink layer can stick to receiving paper during printing, and if the lubricating agent is added in an amount of more than 10 parts by weight, the lubricating agent can be separated from the binder and transferred together with the dye to the lubricating heat-resistant layer opposite the dye layer of the ribbon, so that it can contaminate the thermal head of the printer during printing, thus shortening the life span of the thermal head.

If the dye is contained in the transfer ink layer 30 in an amount of less than 50 parts by weight based on 100 parts by weight of the binder, a sufficient color density cannot be obtained during printing, and if it is contained in an amount of more than 200 parts by weight, the adhesion of the dye to the base film will be insufficient, so that the dye can leak from the transfer ink layer to contaminate the lubricating heat-resistant layer and to shorten the thermal head.

In the present invention, the transfer ink layer 30 contains exfoliated layered inorganic nanoparticles or exfoliated layered double hydroxide nanoparticles in the binder resin. Thus, the coating surface of the transfer ink layer 30 can be uniform, and the dye can be uniformly adsorbed onto the exfoliated layered inorganic nanoparticles or the exfoliated layered double hydroxide nanoparticles to obtain a high dispersing effect during thermal transfer, and can also have high adsorptive power to receiving paper to improve color reproductivity.

Examples of thermally sublimable dyes which can be used in the present invention include Magenta VP, MS Red G, Macrolex Red Violet R, MS Magenta HM-1450, etc. for red color, Waxoline Yellow GFW, Kayaset Yellow GN, Foron Brillinat Yellow 6GL, etc., for yellow color, and Kayaset Blue 714, Waxoline Blue AP-FW, MS Cyan HM-1238, etc. for blue color.

In the present invention, examples of the lubricating agent that is added in order to improve the running between the thermal element and the base film 20 include carboxylate, sulfonate, phosphate, aliphatic amine salt, polyoxyethylene alkylester, silicone oil or synthetic oil.

In the present invention, the transfer ink layer 30 may comprise a releasing agent, an antioxidant, a UV absorber and the like depending on the intended use thereof.

In the present invention, the thickness of the transfer ink layer 30 is preferably about 0.5-2.0 μl. If the coating thickness of the transfer ink layer 30 is less than 0.5 μm, the transfer ink layer 30 will be ineffective so that the dye cannot be adequately transferred to receiving paper, and if the coating thickness exceeds 2.0 μm, the rate of thermal transfer from the thermal head will be decreased to reduce color density.

In the present invention, the transfer protective layer 35 serves to protect a photograph transferred to the uppermost portion after printing of the photograph. It becomes a layer with which the user comes into direct contact when the printed photography is used. Accordingly, the transfer protective layer 35 must have excellent water resistance and show resistance to chemicals such as acetone or toluene. Also, because the transfer protective layer comes in continuous contact with others, it must have excellent physical properties such as abrasion or scratch resistance. The chemical properties such as water resistance or chemical resistance or the physical properties such as abrasion resistance or scratch resistance of the transfer protective layer 35 are determined mainly by the properties of the polymer resin forming the transfer protective layer 35.

Accordingly, exfoliated layered inorganic nanoparticles or exfoliated layered double hydroxide nanoparticles are added to the transfer protective layer 35 of the present invention, they can provide the effect of improving transferability, abrasion resistance and chemical resistance due to the properties of nanoparticle arrays upon application of heat and pressure.

In the present invention, the transfer protective layer 35 contains, based on 100 parts by weight of a binder, 5-40 parts by weight of exfoliated layered inorganic nanoparticles or exfoliated layered double hydroxide nanoparticles. If the exfoliated layered inorganic nanoparticles or the exfoliated layered double hydroxide nanoparticles are contained in an amount of less than 5 parts by weight based on 100 parts by weight of the binder, the effect thereof will insignificant, and if they are contained in an amount of more than 40 parts by weight, they can reduce the transparency of the transfer protective layer.

In the present invention, the thickness of the transfer protective layer 35 is preferably 0.5-2 μm. If the coating thickness of the transfer protective layer 35 is less than 0.5 μm, the printed photograph cannot be sufficiently protected, and if the coating thickness of the transfer protective layer 35 exceeds 2 μm, the transfer protective layer cannot sufficiently adhere to the surface of the photograph, so that wrinkles or debris can occur on the surface of the transfer protective layer.

In another aspect, the present invention is directed to a method for manufacturing a thermal transfer (printing) ribbon, the method comprising the steps of: (a) forming a first adhesive layer on one surface of a base film; (b) forming on the first adhesive layer a lubricating heat-resistant layer containing exfoliated layered inorganic nanoparticles or exfoliated layered double hydroxide nanoparticles; (c) forming a second adhesive layer on the surface opposite the surface of the base film on which the lubricating heat-resistant layer is formed; and (d) forming on the second adhesive layer a transfer ink layer and a transfer protective layer, which contain exfoliated layered inorganic nanoparticles or exfoliated layered double hydroxide nanoparticles.

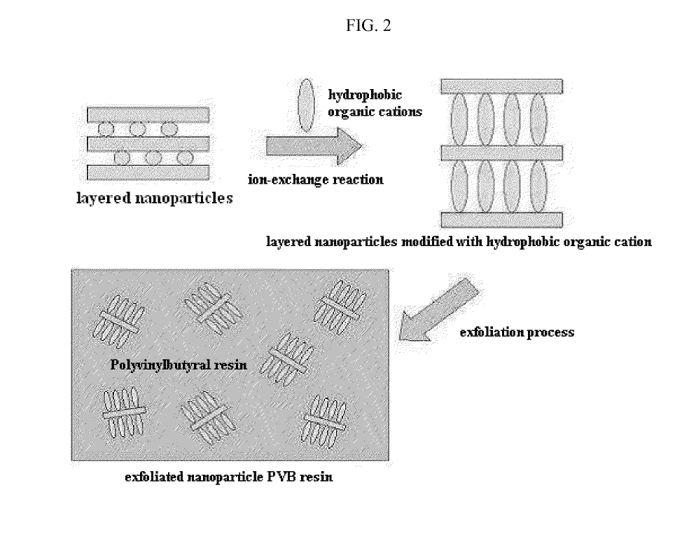

In a method of manufacturing the thermal transfer ribbon according to the present invention, as shown in FIG. 2, layered inorganic nanoparticles are ionically bonded with hydrophobic organic anions, so that they are modified into hydrophobic layered inorganic nanoparticles compatible with hydrophobic organic compounds. Then, the hydrophobically modified layered inorganic nanoparticles are exfoliated, and the exfoliated hydrophobic inorganic nanoparticles are mixed with the binder polymer, thereby preparing an exfoliated hydrophobic inorganic nanoparticle resin.

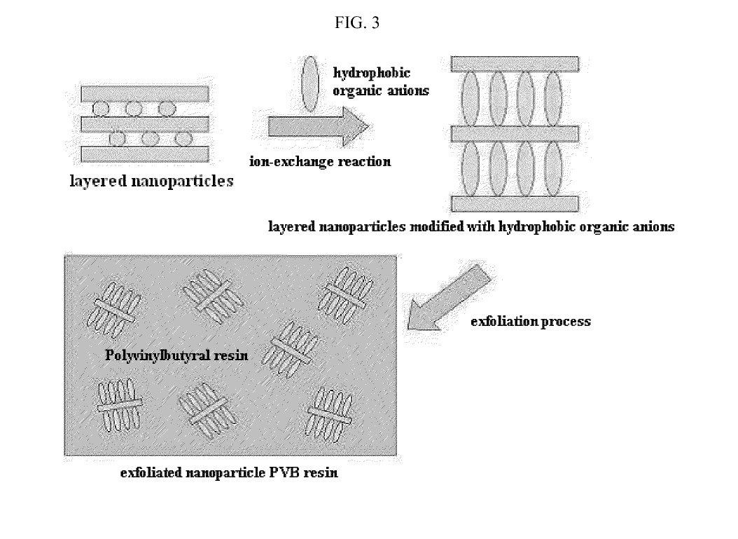

In a method of manufacturing the thermal transfer ribbon according to the present invention, as shown in FIG. 3, layered double hydroxide nanoparticles are ionically bonded with hydrophobic organic cations, so that they are modified into hydrophobic layered double hydroxide nanoparticles compatible with hydrophobic organic compounds. Then, the hydrophobically modified layered double hydroxide nanoparticles are exfoliated, and the exfoliated hydrophobic layered double hydroxide nanoparticles are mixed with the binder polymer, thereby preparing an exfoliated hydrophobic layered hydroxide nanoparticle resin.

The hydrophobic exfoliated layered inorganic nanoparticle resin prepared through the above-described process shown in FIG. 2 is contained in a lubricating heat-resistant layer coating solution, and the coating solution is applied onto the first adhesive layer of a base film to form a lubricating heat-resistant layer. On the surface opposite the surface of the base film on which the lubricating heat-resistant layer is formed, a second adhesive layer is formed. Then, a transfer ink layer coating solution and a transfer protective layer coating solution, which contain the exfoliated hydrophobic inorganic nanoparticle resin, are applied to the second adhesive layer to form a transfer ink layer and a transfer protective layer, thereby manufacturing a thermal transfer ribbon.

Also, the hydrophobic exfoliated layered double hydroxide nanoparticle resin prepared through the above-described process shown in FIG. 3 is contained in a lubricating heat-resistant layer coating solution, and the coating solution is applied onto the first adhesive layer of a base film to form a lubricating heat-resistant layer. On the surface opposite the surface of the base film on which the lubricating heat-resistant layer is formed, a second adhesive layer is formed. Then, a transfer ink layer coating solution and a transfer protective layer coating solution, which contain the exfoliated hydrophobic layered double hydroxide nanoparticle resin, are applied to the second adhesive layer to form a transfer ink layer and a transfer protective layer, thereby manufacturing a thermal transfer ribbon.

Examples of coating techniques which can be used in the present invention include bar coating, gravure coating, comma coating, knife coating, roll coating, etc.

Hereinafter, the present invention will be described in further detail with reference to examples.

It will be obvious to a person having ordinary skill in the art that these embodiments are merely for illustrative purposes, and the scope of the present invention should not be construed as being limited to the above described embodiments.

### Example 1

### Manufacture of Thermal Transfer Ribbon Containing Exfoliated Montmorillonite Inorganic Nanoparticles

1-1: Preparation of Hydrophobic Layered Inorganic Nanoparticles

2 wt % of montmorillonite (Closite Na-NMT, Nonoclay) and 1 wt % of dimethyloctadecyl ammonium chloride [CH₃(CH₂)₁₇]₂(CH₃)₂N⁺Cl⁻ were added to 97 wt % of distilled water, and the mixture was stirred at room temperature for 6 hours. The stirred suspension was collected and dried at 80° C., thus preparing hydrophobic layered inorganic nanoparticles having a mean particle size of less than 2000 nm.

1-2: Formation of First Adhesive Layer and Lubricating Heat-Resistant Layer

3 wt % of p-chlorophenol was mixed with 97 wt % of toluene, and the mixture was applied onto one surface of a 5,6-μm-thick polyethylene terephthalate film (XR30, Toray Saehan Inc., Korea) using a Meyer bar coater, and then dried at 105° C., thus forming a first adhesive layer. To the formed first adhesive layer, a lubricating heat-resistant layer coating solution of Table 1, which contained the hydrophobic layered inorganic nanoparticles prepared in Example 1-1, was applied by gravure coating. Then, the applied coating solution was dried at 105° C., thus forming a 1-μm-thick lubricating heat-resistant layer. The formed coating layer was cured at 60° C. for 5 days.

TABLE 1

| | | | polyisocyanate | phosphate ester | |
|---|---|---|---|---|---|
| | montmorillonite | polyvinylbutyral | (Korea, Shinsung | surfactant (Japan, Dai- | methylethyl- |
| | layered inorganic | (Japan, Sekisui | Chemical NCO | Ichi Jogyo Seiyaku Co. | ketone/toluene |
| Sort | nanoparticle | Chemical BX-55) | contents 12.5%) | plysurf A208) | (1/1) |
| contents | 10 | 10 | 12.5 | 2.5 | 65 |
| (wt %) | | | | | |

1-3: Formation of Second Adhesive Layer and Transfer Ink Layer

To the surface opposite the surface of the polyethylene terephthalate film on which the lubricating heat-resistant layer has been formed as described in Example 1-2, a polyurethane coating agent (AB-4550, Anjin Inc.) was applied to a thickness of 0.1 μm, and then dried at 105° C., thus forming a second adhesive layer. The formed second adhesive layer was coated by gravure coating with dye coating solutions of Table 2 below, which contained the layered inorganic nanoparticles prepared in Example 1-1. Then, the formed coating layers were dried at 105° C., thus forming yellow, magenta and cyan dye layers, each having a thickness of 1 μm.

TABLE 2

| | yellow | magenta | cyan |
|---|---|---|---|
| Sort | (wt %) | (wt %) | (wt %) |
| Dyes | 5 | 5 | 5 |
| polyvinylbutyral | 4 | 4 | 4 |
| (Japan, Sekisui Chemical BX-55) | | | |
| Silicon oil(Japan, Shinets Co. KF-393) | 0.1 | 0.1 | 0.1 |
| montmorillonite layered inorganic | 0.9 | 0.9 | 0.9 |
| nanoparticle | | | |
| methylethylketone/toluene/ | 90 | 90 | 90 |
| dimethylformamide (1:2:1) | | | |

1-4: Formation of Transfer Protective Layer

A coating solution of Table 3 was applied by gravure coating to the second adhesive layer formed according to Example 1-3, and was then dried at 105° C., thus forming a 2-μm-thick transfer protective layer.

TABLE 3

| | montmorillonite | polymethylmeta | fatty acid Quarternary | methylethyl- |
|---|---|---|---|---|
| | layered inorganic | acrylrate | ammonium salt (Dong- | ketone/toluene |
| Sort | nanoparticle | (Rohm&Hass, B-60) | bo chemical AS700s) | (1/1) |
| contents | 5 | 20 | 5 | 70 |
| (wt %) | | | | |

### Example 2

### Manufacture of Thermal Transfer Ribbon Containing exfoliated Layered Double Hydroxide

2-1: Preparation of Layered Double Hydroxide

Metal precursors magnesium nitrate ([Mg(NO₃)₂.6H₂O]) and aluminum nitrate ([Al(NO₃)₃.9H₂O]) were dissolved in 500 ml of distilled water at a molar ratio of Mg:Al of 2:1. The solution was titrated with sodium hydroxide to a pH of 10.0. Then, the titrated solution was subjected to hydrothermal synthesis at 100° C. for about 24 hours, thus preparing a layered double hydroxide (LDH) suspension. The suspension was centrifuged to obtain a solid which was then dispersed in distilled water and centrifuged. Such dispersion and centrifugation processes were repeated more than three times. The resulting solid was freeze-dried or dried at 80° C., thus obtaining layered double hydroxide as powder.

2-2: Preparation of Layered Double Hydroxide Modified with Hydrophobic Organic Anions

2 wt % of the layered double hydroxide prepared in Example 2-1 and 1 wt % of sodium dodecyl sulfite [CH₃(CH₂)₁₁SO₄⁻Na⁺] were added to 97 wt % of distilled water, and the mixture was stirred at 60° C. for 24 hours. The stirred suspension was collected and dried at 80° C. to yield hydrophobic organic anion-modified layered double hydroxide nanoparticles having a mean particle size of 100-200 nm.

2-3: Formation of First Adhesive Layer and Lubricating Heat-Resistant Layer

3 wt % of p-chlorophenol and 97 wt % of toluene were mixed with each other, and the mixture was applied to one surface of a 5.6-μm-thick polyethylene terephthalate film (XR30, Toray Saehan Inc., Korea) using a Meyer bar coater, and then dried at 105° C., thus forming a first adhesive layer. Then, a lubricating heat-resistant layer coating solution of Table 4 below, which contained the exfoliated hydrophobic layered double hydroxide nanoparticles prepared in Example 1-2, was applied by gravure coating to the formed first adhesive layer, and then dried at 105° C., thus forming a 1-μm-thick lubricating heat-resistant layer. The formed coating layer was cured at 60° C. for 5 days.

TABLE 4

| | | | polyisocyanate | phosphate ester | |
|---|---|---|---|---|---|
| | Metal layered | polyvinylbutyral | (Korea, Shinsung | surfactant (Japan, Dai- | methylethyl- |
| | double hydroxide | (Japan, Sekisui | Chemical NCO | Ichi Jogyo Seiyaku Co. | ketone/toluene |
| Sort | nanoparticles | Chemical BX-55) | contents 12.5%) | plysurf A208) | (1/1) |
| contents | 10 | 10 | 12.5 | 2.5 | 65 |
| (wt %) | | | | | |

2-4: Formation of Second Adhesive Layer and Transfer Ink Layer

To the surface opposite the surface of the polyethylene terephthalate film on which the lubricating heat-resistant layer has been formed as described in Example 2-3, a polyurethane coating agent (AB-4550, Angin Inc., Korea) was applied to a thickness of 0.1 μm, and then dried at 105° C., thus forming a second adhesive layer. Then, dye coating solutions of Table 5 below, which contained the layered double hydroxide nanoparticles prepared in Example 2-2, were applied by gravure coating to the second adhesive layer, and then dried at 105° C., thus forming yellow, magenta and cyan dye layers, each having a thickness of 1 μm.

TABLE 5

| | yellow | magenta | cyan |
|---|---|---|---|
| Sort | (wt %) | (wt %) | (wt %) |
| Dyes | 5 | 5 | 5 |
| polyvinylbutyral | 4 | 4 | 4 |
| (Japan, Sekisui Chemical BX-55) | | | |
| Silicon oil(Japan, Shinets Co. KF-393) | 0.1 | 0.1 | 0.1 |
| Metal layered double hydroxide | 0.9 | 0.9 | 0.9 |
| nanopartides | | | |
| methylethylketone/toluene/ | 90 | 90 | 90 |
| dimethylformamide (1:2:1) | | | |

2-5: Formation of Transfer Protective Layer

A coating solution of Table 6 below was applied by gravure coating to the second adhesive layer formed as described in Example 2-4. The formed coating solution was dried at 105° C., thus forming a 2-μm-thick transfer protective layer.

TABLE 6

| | Metal layered | polymethylmeta | fatty acid Quarternary | methylethyl- |
|---|---|---|---|---|
| | double hydroxide | acrylrate | ammonium salt (Dong- | ketone/toluene |
| Sort | nanoparticles | (Rohm&Hass, B-60) | bo chemical AS700s) | (1/1) |
| contents | 5 | 20 | 5 | 70 |
| (wt %) | | | | |

### Comparative Example 1

### Manufacture of General Thermal Transfer Ribbon Containing Silica

A thermal transfer ribbon was manufactured in the same manner as described in Examples 1 and 2, except that silica (Oriental Chemical Industries, Korea) was used instead of montmorillonite and layered double hydroxide nanoparticles.

### Comparative Example 2

### Manufacture of General Thermal Transfer Ribbon Containing Talc

A thermal transfer ribbon was manufactured in the same manner as described in Examples 1 and 2, except that talc (Microace P-3, Japan) was used instead of montmorillonite and layered double hydroxide nanoparticles.

### Test Example 1

### Measurement of Heat Resistance, Color Uniformity and Abrasion Resistance

Each of the thermal transfer ribbons manufactured in Examples 1 and 2 and Comparative Examples 1 and 2 was cut and attached to an identification card printing sublimation printer (Persona C30, Fargo, USA) according to the color arrangement and size, and then a black image was printed on a PVC card (ISO standard size) using the printer in order to measure whether the film would be damaged by heat during printing and to measure color uniformity after printing and abrasion resistance.

The measurement of heat resistance was performed by printing 100 cards and counting the number of cards having a film damaged by heat. The measurement of color uniformity was performed by measuring the optical densities (OD) of 10 printed cards at five portions (corners and a central portion) per card using a Spectroeye spectrophotometer (Macbeth, USA) and calculating the standard deviations of the optical densities. In the measurement of abrasion resistance, the printed card was kept in contact with an abrasion wheel CS10F, while the abrasion wheel was rotated under a load of 500 g and 60 rpm by an abrasion resistance tester (5135, Taber, USA), and the number of revolutions at which the printed image started to be damaged by heat was measured at intervals of 50 revolutions. The measurement results are shown in Table 7 below.

As can be seen in Table 7, the thermal printing ribbons manufactured in Examples 1 and 2 were very excellent in heat resistance, color uniformity and abrasion resistance compared to the thermal transfer ribbons manufactured in Comparative Examples 1 and 2.

TABLE 7

| | Heat resistance | Color | Abrasion resistance |
|---|---|---|---|
| Sort | (number) | uniformity | (rev count) |
| Example 1 | 0 | 0.2075 | 850 |
| Example 2 | 0 | 0.2263 | 850 |
| Comparative | 5 | 0.3578 | 650 |
| Example 1 | | | |
| Comparative | 3 | 0.3089 | 700 |
| Example 2 | | | |

### INDUSTRIAL APPLICABILITY

As described above, the thermal transfer ribbon according to the present invention is prevented from thermal deformation and tearing due to the excellent heat resistance of the lubricating heat-resistant layer and causes no damage to a thermal transfer head during image printing. Also, the transfer protective layer of the thermal transfer ribbon according to the present invention has greatly improved durability to reduce the abrasion of the ribbon, and each layer of the ribbon is uniform to improve the printing sensitivity of the ribbon. Accordingly, the thermal transfer ribbon of the present invention can provide many advantages in terms of image print quality and cost.

Although the present invention has been described in detail with reference to the specific features, it will be apparent to those skilled in the art that this description is only for a preferred embodiment and does not limit the scope of the present invention. Thus, the substantial scope of the present invention will be defined by the appended claims and equivalents thereof.

What is claimed is:

1. A thermal transfer ribbon wherein a second adhesive layer, a transfer ink layer and a transfer protective layer are formed on one surface of a base film having a lubricating heat-resistant layer and a first adhesive layer formed on the other surface thereof, in which the lubricating heat-resistant layer, the transfer ink layer and the transfer protective layer contain exfoliated layered inorganic nanoparticles or exfoliated layered double hydroxide nanoparticles.

2. The thermal transfer ribbon of claim 1, the exfoliated layered inorganic nanoparticles are layered silicate.

3. The thermal transfer ribbon of claim 2, the layered silicate is smectite clay minerals selected from group consisting of montmorillonite, bentonite, hectorite, fluorohectorite, saponite, beidelite, nontronite, stevensite, vermiculite, volkonskoite, sauconite, magadite, kenyalite, and their derivatives.

4. The thermal transfer ribbon of claim 1, the exfoliated layered double hydroxides are represented by the following formula 1:
[M²⁺₁₋ₓN³⁺ₓ(OH)₂][Aⁿ⁻]_{x/n}.yH₂O [Formula 1]
Where, M represents a divalent metal cation, N represents a trivalent metal cation, A represents n charged anionic chemical, x is an integer of more than 0 but smaller than 1, y is a positive number, and n is an integer.

5. The thermal transfer ribbon of claim 1, the lubricating heat-resistant layer contains, based on 100 parts by weight of a binder, 5-60 parts by weight of exfoliated layered inorganic nanoparticles or exfoliated layered double hydroxide nanoparticles, 20-130 parts by weight of a curing agent and 10-50 parts of an agent for providing activity.

6. The thermal transfer ribbon of claim 1, the thickness of the lubricating heat-resistant layer is 0.5-2.0 μm.

7. The thermal transfer ribbon of claim 1, the transfer ink layer contains, based on 100 parts by weight of a binder, 2-30 parts by weight of exfoliated layered inorganic nanoparticles or exfoliated layered double hydroxide nanoparticles, 1-10 parts by weight of a lubricating agent and 50-200 parts by weight of a dye.

8. The thermal transfer ribbon of claim 1, the thickness of the transfer ink layer is 0.5-2.0 μm.

9. The thermal transfer ribbon of claim 1, the transfer protective layer contains, based on 100 parts by weight of a binder, 5-40 parts by weight of exfoliated layered inorganic nanoparticles or exfoliated layered double hydroxide nanoparticles.

10. The thermal transfer ribbon of claim 1, the thickness of the transfer protective layer is 0.5-2.0 μm.

11. A method for manufacturing a thermal transfer ribbon, the method comprising the steps of:
(a) forming a first adhesive layer on one surface of a base film;
(b) forming on the first adhesive layer a lubricating heat-resistant layer containing exfoliated layered inorganic nanoparticles or exfoliated layered double hydroxide nanoparticles;
(c) forming a second adhesive layer on the surface opposite the surface of the base film on which the lubricating heat-resistant layer is formed; and
(d) forming on the second adhesive layer a transfer ink layer and a transfer protective layer, which contain exfoliated layered inorganic nanoparticles or exfoliated layered double hydroxide nanoparticles.

12. The method of claim 11, the exfoliated layered inorganic nanoparticles are layered silicate.

13. The method of claim 12, the layered silicate are modified with hydrophobic organic cations.

14. The method of claim 13, the hydrophobic organic cations are selected from the group consisting of primary to quaternary ammonium ions, primary to quaternary phosphonium ions, and mixtures thereof.

15. The method of claim 11, the exfoliated layered double hydroxide nanoparticles are modified with hydrophobic organic anions.

16. The method of claim 15, the hydrophobic organic anions are selected from the group consisting of alkyl sulfate ions, alkyl alcoholate ions, alkyl carboxylate ions, and mixtures thereof.
